(19) United States
(12) Patent Application Publication
(10) Pub. No.: US 2010/0312691 A1
(43) Pub. Date: Dec. 9, 2010

(54) Loan Quotation System and Method

(76) Inventor: Alan W. Johnson, JR., Denver, CO (US)

Correspondence Address: BISHOP & DIEHL, LTD., 1320 TOWER ROAD, SCHAUMBURG, IL, 60173, US

(21) Appl. No.: 12/778,461

(22) Filed: May 12, 2010

Related U.S. Application Data
(60) Provisional application No. 61/177,584, filed on May 12, 2009.
(60) Provisional application No. 61/264,153, filed on Nov. 24, 2009.

(51) Int. Cl. G06Q 40/00

(52) U.S. Cl. 705/38

(57) ABSTRACT

A loan quotation system and method is provided having a consumer data entry point device operatively coupled, via a network, to one or more severs for entering data and receiving a responsive loan quotation.

### CROSS-REFERENCE TO RELATED APPLICATIONS

This utility patent application claims the benefit of U.S. Provisional Patent Application Ser. No. 61/177,584, filed on May 12, 2009, and U.S. Provisional Patent Application Ser. No. 61/264,153, filed on Nov. 24, 2009, the disclosures of which are incorporated herein, by reference.

This application also hereby incorporates by reference U.S. Patent Publication Nos.: 2005/0273406 to Lebda et al.; 2006/0100944 to Reddin et al.; 2009/0076972 to Witchel et al.; 2008/0109349 to Parthasarathy; and, 2003/0036993 to Parthasarathy.

### TECHNICAL FIELD OF THE INVENTION

The present invention is generally related to an apparatus and method for providing consumers with loan quotations, and more particularly, to an apparatus and method whereby consumers can enter personal information and, in response to the entered data, obtain tailored loan quotations in a convenient setting.

### BACKGROUND OF THE INVENTION

Obtaining a consumer loan can be a very tedious process. There can be a large number of forms to complete regarding each loan application. Accordingly, if an applicant wants to apply for more than one loan, then multiple forms must be completed. Furthermore, obtaining the forms and returning them to one or more lenders can take an enormous amount of time and effort.

Accordingly, in what might be called the first model of online web loan quoting is the ‘standard’ model originally devised by LENDINGTREE, Charlotte, N.C., which is the most common replicated online mortgage pricing model with leads today. In this model, a user enters all their personal information online, and this information is sold to lenders (up to 5 lenders, in the case of LENDINGTREE) and transfers all the lead information to the lender, who prices the loans, replies back with an offer and calls the borrowers. Most typically, users' personal information is immediately sent to many lenders and thus they will receive calls, solicitations and various ‘subsequent’ pricing quotes as the lenders ‘compete’ for their business. Responses back from the competing (5) lenders will take time. When all responses from a lender have been received, LENDINGTREE contacts the borrower via email and then requests the user login to view their offers. Other mortgage lead source companies do the same process, except they only sell the leads to X number of lenders and do not require any follow-up or price quotes. The lenders simply do whatever they want with the leads.

### SUMMARY OF THE INVENTION

In accordance with the present invention, an apparatus and system is provided whereby a consumer can enter personal information and obtain tailored, consumer eligible loan quotations in a setting that is convenient for the consumer. In an embodiment, the system can include a consumer data entry point device operatively coupled, via a network, to one or more severs for entering data and receiving a responsive loan quotation. Also, a lender platform is provided for generating the loan quotation and receiving contact information for a consumer upon permission being granted by the consumer.

### BRIEF DESCRIPTION OF THE DRAWINGS

The invention may be better understood with reference to the following drawings. The components in the drawings are not necessarily to scale, emphasis instead being placed upon illustrating the principles of the invention. In the drawings, like reference numbers designate corresponding parts throughout.

FIG. 1 is a simplified functional block diagram of a loan quotation system in accordance with the present invention having a consumer data entry point device comprising a handheld mobile device for entering personal data and receiving a responsive loan quotation or report;

FIG. 2 is an elevation view of the handheld mobile device of FIG. 1 having an integral touch screen display with an icon provided thereon to initiate a search for one or more loan products;

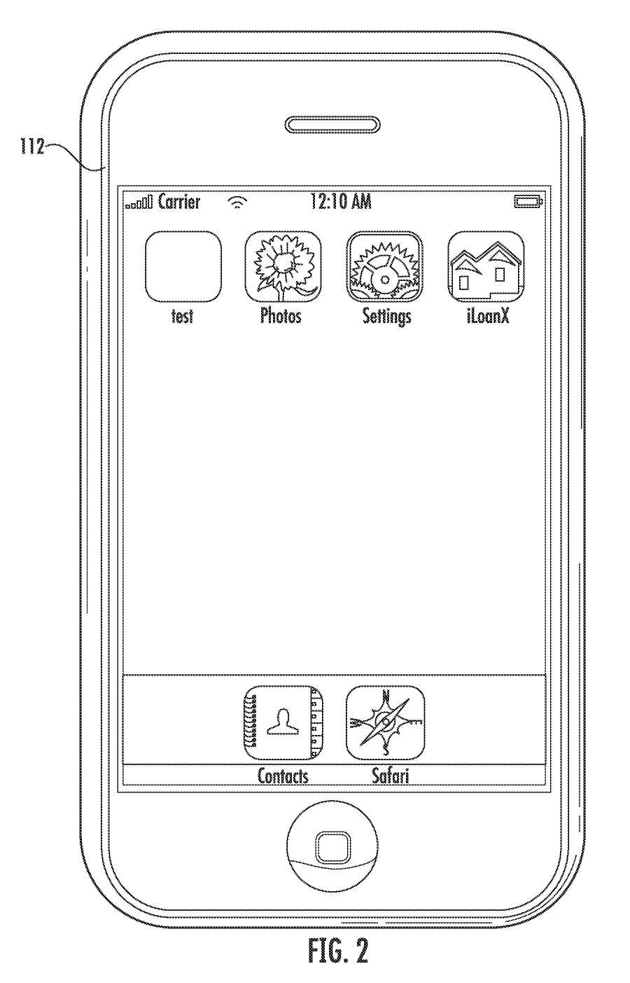

FIG. 3 is an elevation view of the handheld mobile device of FIG. 1 displaying a form for entering loan criteria information;

FIG. 4 is an elevation view of the handheld mobile device of FIG. 2 displaying confirmation that a search is being performed for the requested loan products;

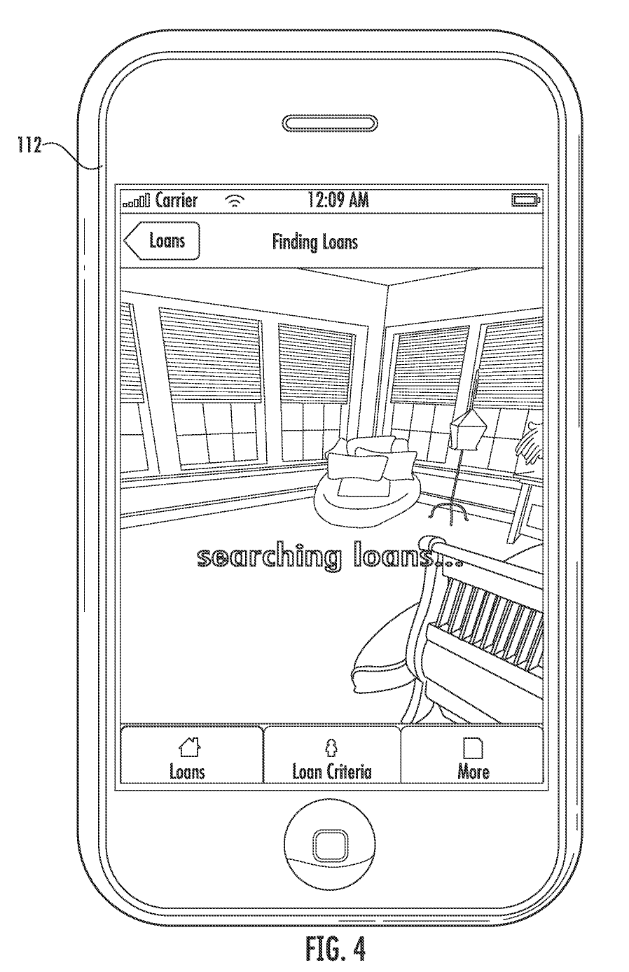

FIG. 5 is an elevation view of the handheld mobile device of FIG. 2 displaying a list of offered loan products;

FIG. 6 is an elevation view of the handheld mobile device of FIG. 2 displaying details of an offered loan product; and,

FIG. 7 is an elevation view of the handheld mobile device of FIG. 2 displaying confirmation that contact information is being sent to a prospective lender.

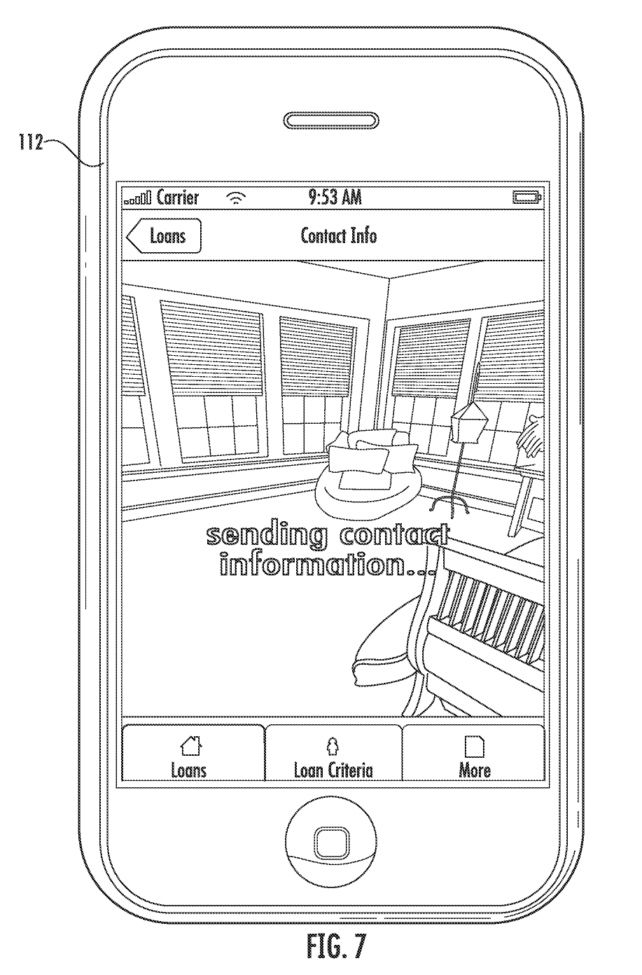

### DETAILED DESCRIPTION OF THE INVENTION

The following descriptions of detailed embodiments are for exemplifying the principles and advantages of the inventions. They are not to be taken in any way as limitations on the scope of the invention.

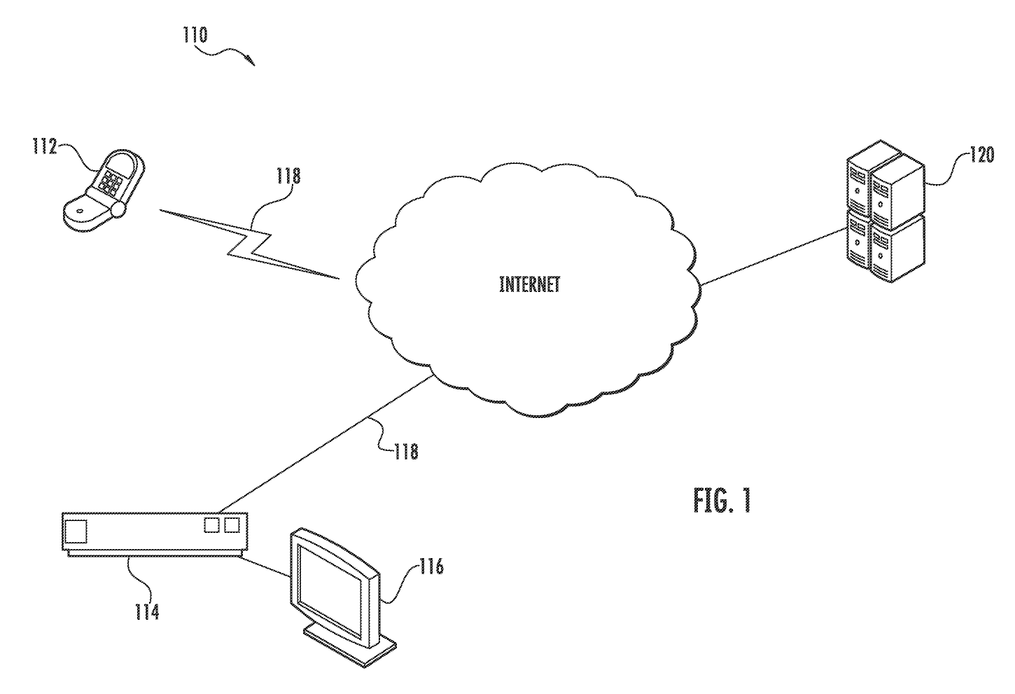

Turning to FIG. 1, a loan quotation system 110 is depicted in accordance with the present invention. The system 110 can include, but is not necessarily limited to, a plurality of consumer data entry point devices, comprising cellular telephones 112 or cable set top boxes 114 (coupled to display 116), that are operative coupled via the Internet or other bi-directional communication link(s) 118 to a remote server(s) 120.

As explained in detail further herein, the loan quotation system delivers consumers native consumer data entry point device applications that provide residential mortgage loan quote information from individual or multiple brokers, banks and lenders simultaneously. Likewise, the system provides mortgage brokers, banks and other lenders a unique advertising method and quoting technology to reach consumers on their data entry point devices. In addition, the system provides mortgage brokers, banks and other lenders a combined eligibility and pricing engine, lead management system and customer relationship management system.

The consumer data entry point devices 112 can be conventional cellular telephones, conventional cable set top boxes, gaming consoles, digital video recording devices or handheld devices for sending and receiving information over a communication network such as a conventional cellular telephone network or cable network connected to the Internet. In an embodiment, one or more of the consumer data entry points can be an Internet and multimedia enabled smartphone such as the IPHONE by Apple, Inc., Cupertino, Calif. or the DROID by Motorola, Schaumburg, Ill. As such, the cellular telephones can download software applications from the Internet and execute these applications.

Preferably, but not necessarily, the consumer data entry point is operatively coupled by conventional means, via a conventional network, to one or more servers 120 for entering personal data wherein the personal data is securely transmitted by conventional means over the network. Loaded on the consumer data entry point is a computer program or application that can be downloaded from the servers 120 or can be downloaded from another server that offers various applications for downloading.

In an embodiment, a basic loan quote process is provided by a user entering data into his or her cellular telephone or other data entry point device wherein the data is sent to a consumer advertising platform. In response to the received entered data, the platform provides a loan quote and loan qualification response to the data entry point device of the user. Next, the user can select a program and request a contract from one of the loan providers. This selection is provided to the consumer advertising platform which relays the information to the selected lender via an XML, email or transfer to a lender platform.

Also provided is a rate watch advertisement and selection process wherein a user enters data into his or her cellular telephone or other data entry point device. This data is then sent to the consumer advertising platform wherein a rate watch monitoring action is performed and the user is provided, via his or her data entry point device or an email, with a notification or rate watch report that a target rate has been satisfied.

Moreover, the system provides a daily rate report advertisement and selection process wherein a user provides data to the consumer advertising platform via his or her cellular telephone or other data entry point device. As a result, a daily rate report generating action is performed and the user is provided, via his or her data entry point device or an email, with a notification or daily rate report of the best currently available loan quotes.

As stated previously, the system includes a data entry point device application. Preferably, but not necessarily, the application is consumer facing on the front end of the data entry point device and facilitates configuration, collection, display and selection of loan product(s) and information. Accordingly, the application facilitates a user in entering loan criteria and sending a loan quote request to the consumer advertising platform. Moreover, the application loaded on the data entry point device provides for receiving a response from the consumer advertising platform wherein a user can select a desired loan program. As a result of making the selection, a request for contact of the user, by the lender, is sent by the application to the consumer advertising platform.

Turning to the consumer advertising platform, this is a pricing and tracking system for providing rate quote responses, rate watch tracking and daily rate reporting. A loan quote response process starts by receiving a loan request from a user via a cellular telephone or other data entry point device wherein the data within the loan request is parsed and inserted or updated within a database. Next, those lenders available to advertise are determined along with product eligibility and qualification. Then, pricing is determined and the select top number of results is obtained. Further, tracking of loan quotes and impressions are provided within a form XML response that is displayed or sent to the cellular telephone or other data entry point device used by the user in requesting the loan quote.

Likewise, the consumer advertising platform provides a rate watch action that occurs by a loan quote request being received wherein the data within the loan quote is parsed and inserted or updated within a database. Next, a periodic trigger event is determined to occur followed by a check of product eligibility and qualification. Pricing is then determined and the determined best current rate(s) are compared with the target rate. If the target rate is satisfied, then a notification is generated and sent to the cellular telephone of the user, via email, or other data entry point device utilized in making the request.

Also, the consumer advertising platform provides a daily rate report that begins by a loan quote request being received wherein the data within the loan quote request is parsed and inserted or updated within a database. Next, a periodic trigger event is determined to occur followed by a check of product eligibility and qualification. Pricing is then tabulated and the calculated best products and rates are determined whereby a notification of the same is generated and sent to the cellular telephone of the user or other data entry point device utilized in making the request.

In addition, the consumer advertising platform provides a “contact me” selection response wherein the process begins by receiving a loan selection. As a result, user information and advertised product information is gathered and written into tracking tables. A formulated response is also composed and sent via XML, post or email and to the lender's platform or third party lead management system.

In an embodiment, the consumer advertising platform shares all characteristics and functionality from the system lender platform. However, it also has unique functionality for the management of all lender investor guidelines, rate sheets, adjustments, determining which products to display and support for lender preference settings for characteristics of loan profiles they wish to pursue, what margins to bid at, what closing costs to display, quotas for impressions, clicks and number of daily referrals.

The consumer advertising platform is the place where lenders can configure their desired settings for each of the devices. It is the place where users submit loan quote requests and the system performs all necessary eligibility and pricing for all loans, determining top loans and then replying back to the devices in either a synchronous or asynchronous automated bidding method. The consumer advertising platform also tracks impressions, clicks, transfers, the rate watches and daily rate reports and other metrics for each device that has these features activated. For rate watches and daily rate reports, a triggering event executes an automatic pricing run for a particular devices' loan criteria profile. If it finds that the best rate option is less than or equal to the target rate setting, notifications are sent via email and also return notification to the device, when possible. Specific best execution daily rate reports are sent at some interval, such as once a day to the user, if this feature is enabled.

In an embodiment, configuration options for automatic bidding and for a lender to filter which loans they want display includes, but is not limited to: lenders' banking investors list (all rates, guidelines, adjustments and other data related to build pricing); bidding margins (dollar or point based); local pricing adjustments to tweak the pricing based upon loan characteristics and product specifics; closing cost fees; origination fees; APR related fees; POC related fees; operating states; transaction types; minimum loan amounts; maximum LTVs; maximum daily impressions; maximum detail page clicks; customer or source driven lender selection and, maximum daily referrals.

All investor information for each broker, bank and lender can be maintained and used in eligibility and pricing determinations. The consumer advertising platform may be one or many servers and databases, and every investor and the guideline and pricing data can be maintained and synchronized from a master database via the system client sync technology. The master database preferably runs bots and has automated processes to import all lender data every day, as frequently as pricing is released by the various investors and banks.

A series of tables filled with lender data, and multiple loan programs are synchronized and then utilized when a pricing request is made. The structure of the data and the methods by which the data is evaluated and pricing selected can be based on data that includes, but is not limited to: Lender; LenderAdjustment; LenderAdjustment H; LENDERADJUSTMENTTYPE; LENDERPLAN; LENDERFEE; LenderCredit; LenderBot; LENDERPRICESHEET; LENDERPRICESHEETRATES; LenderProduct; LenderProductLTV; LenderRegion; LenderSRPAmounts; LenderSRPStates; LenderSubprimePricesheet; LenderSRPProduct; LenderSRPSchedule; LenderSubprimePricesheetRates; LenderSubprimePricesheetProducts; PRICESHEET; and, WORKBOOK.

The number of rate quote impressions and clicks are tracked by the system consumer advertising platform for all devices and every request for contact and transfer of information to a lender is tracked. Information tracked includes, but is not limited to: PartnerId; SourceId; LoanId; LoanName; QuoteDate; QuoteTime; QuoteRate; PageViewed; SentDate; SentResult; ImpressionDate; ImpressionCount; and, PriceRequestCount.

As stated previously, the lender platform provides functions such as a lender local combined product Pricing and Eligibility Engine (PPE), a Lead Management System (LMS), and a Customer Relationship Management system (CRM). Moreover, the lender platform may provide loan quotations via a conventional website or the like that is associated with a particular lender or a partner of the lender. With regard to automated bidding, the lender platform performs a process that includes the steps of: receiving a lead XML; parsing; inserting and/or updating information; overriding engine variable resetting process; assignment process; product eligibility and pricing process; saving scenarios and selection of programs; emails, tasks and notification process; formulating an XML response, if needed; and, sending XML response. In an embodiment, third-party mortgage lead sources can send XML information for automatic lead distribution, assignment, product pricing and eligibility, and customer relationship management.

With regard to manual pricing, the lender platform performs a process that can include, for example, the steps of: editing loan information; recommending products based on pricing and/or eligibility; reediting loan information wherein changes are made on-the-fly and recalculated if desired; viewing details; saving scenarios; exporting data to third party systems via XML or a Fannie Mae 3.2 file; requesting loan locks, if desired; changing statuses, if desired. In an embodiment, mortgage leads can be manually entered, and imported from Fannie Mae 3.2 files.

With regard to rate watching, the lender platform performs a process that can include, for example, the steps of: active rate watch, set target rate; triggering event; gathering loan information; determining product eligibility and/or qualification; determining pricing; comparing best current rate with target rate; if the target rate is met, then generate a notification and send.

With regard to daily rate reports, the lender platform performs a process that can include, for example, the steps of: activating daily rate report; triggering event; gathering loan information; determining product eligibility and/or qualification; determining pricing; determining best products and/or rate(s); generating notification and sending same.

With regard to assignments, the lender platform performs a process that can include, for example, the steps of: gathering loan information and assignment “rules”; turning rules and variables into executable query structure; evaluating rules; determining passing assignment rules; looking at priority rankings and select assignment rule; gathering information on “who” is a member of the group(s) for the selected assignment rule; failing potential assignees based on states, over quota, and the like; arriving at final list; and optionally using weight factors, assign lottery balls; executing assignment algorithms such as fully weighted, round robin, last to receive an assignment to select lottery ball and make final loan officer or branch assignment.

With regard to overrides, the lender platform provides an overrides engine that performs a variable resetting process that can include, for example, the steps of: gathering loan information and override “rules”; turning rules and variable(s) into executable query structure; evaluating rules; resetting variable(s); saving into database. The override process is desired in setting variable(s) on-the-fly to cause the system to price, email, spawn tasks or react differently to different “profile(s)” of incoming leads and/or mortgage data.

With regard to eligibility and pricing, the lender platform provides a process that can include, for example, the steps of: gathering loan information; determining list of lenders to use and pull product data; setting variables, bidding margins, and temporary variables as needed; using loan information and conducting a first hard pass to remove failing products; using remaining products and conducting a second pass to remove failing products by LTV and other variables wherein the failed products are saved into an array; constructing a final qualifying products list wherein qualified products are placed into an array; pricing, which includes margin; executing an adjustment process; and executing an SRP process; determining final selected rate for each qualified products; sorting the results; displaying a list used for display of rates, rate watch comparison and for daily reports; and, saving the scenarios, if necessary.

With regard to email, tasks and notification, the lender platform provides an engine wherein email triggers and tasks creation is based on the status of lead or loan and profiling rules. Emails and task templates can set triggers for future delivery and task and emails to be sent in the future. Accordingly, the process can include, for example, the steps of: a lead and/or loan status change occurring; loan information is gathered; task and/or email rules are gathered; task and/or email rules are converted into queries; task and/or email rules are evaluated to be true or false against the lead information characteristics; check for status match; spawning of task and email triggers; cancellation or deletion of task and emails that are still waiting from the previous status. When an email check event occurs, the system will find the email template to be sent, swap out variables within the email template, send the email, and track information of the sent email.

The lender platform can also include a keyword and rules engine that can include a system of free form rules that are “English language” like and can be written for the various rules engine within the lender platform, including the overrides engine, the adjustment engine, the assignment engine, and the tasks/emails engine. In an embodiment, the English language variables and “verbs” are turned into database fields and execution statements, by which rules are evaluated to be true or not.

In an embodiment, a system traffic cop platform provides intelligent lead distribution to companies on disparate severs and locations to facilitate large loads and traffic. Generally stated, the process implemented by the traffic cop includes, but is not limited to: receiving lead XML; parsing; inserting/updating information; overrides engine variable resetting process; assignment process; determining branch/server/instance to send the lead XML; and, attaching any additional data and forwarding lead XML to selected server/branch/instance.

Desirably, the system traffic cop is a web-based application that acts as a single access point for leads and provides intelligent lead distribution to different lenders based on rankings and rules defined by a lender's corporate staff or the system platform for advertising availability. As part of the advertising platform and/or designed for lead source companies, extremely large lenders and net-branch model lenders that require multiple system servers (or server farms), the system traffic cop sits at the front of numerous system servers or other pricing engine clients, profiles incoming leads matching servers with their ‘desired profiles’, looks at server quotas and re-routes leads intelligently to individual lenders or servers.

In an embodiment, the traffic cop functionality includes, but is not necessarily limited to: support for multiple lender partner companies and/or branches; rules-based ‘lead profiling’ to match a lead to partner; routing of lead to the system or lead partner system; ranking of lender partners to determine routing chance; quota management by source, total and transaction type; and, partner-only view to make quota and profile changes. Desirably, the traffic cop applications handle load and redistribute out to multiple servers, but traffic cop applications can also be stacked to handle nearly unlimited number of servers.

In an embodiment, the system client sync provides backend synchronization for syncing lender, rate, guideline and other product pricing and eligibility information to multiple backend severs and lender's specific system lender platforms. Generally stated, the process implemented by the client sync includes, but is not limited to: periodic or manual triggering event; client application loads XML to determine specific lender(s) information and other data to gather and the master database location; communication to master database; selection to locate new/modified/deleted data; and, update a specified local database.

The system client sync can be a combination of two applications that allow for the maintenance, duplication and synchronization of all guideline and lender data between multiple server databases and database instances. Each application has an XML configuration which dictates its access, order, which tables and ultimately which lender and lender products to synchronize. This allows the system to sync only the lender information that is needed for a particular client. Thus, a master database contains all the data and specific portions of the data are replicated out to different databases depending on specific need. Synchronization preferably happens on scheduled timeframe intervals or is triggered automatically or manually by events such as the release of new ratesheets by a bank.

The system client sync technology is a desired backend piece to the system consumer advertising platform and the mobile application loan quoting service since it allows all the pricing and guideline information to be placed on multiple database servers, which allows for large capacity for handling whatever network traffic and load is placed on the backend from the mobile or TV set-top box device users.

In summary, the mobile loan quote advertising method can include, for example: 1) a base loan quote, response and selection; 2) a rate watch advertisement and selection; and, 3) a daily rate report advertisement and selection. In an embodiment, the base loan quote, response and section process can include: an IPHONE, mobile phone, handheld mobile device, TV set-top box, gaming system, television system or other data entry point device; a consumer advertising platform; a loan quote and/or qualification response to the mobile device; a select program and request contact; a consumer advertising platform; information sent to lender via XML, email or transfer to the lender platform.

The rate watch advertisement and selection process can include, for example: an IPHONE, mobile phone, handheld mobile device, TV set-top box, gaming system, television system or other data entry point device; a consumer advertising platform; a rate watch monitoring action; a data entry point device and email notification to user upon meeting a target rate.

Furthermore, the daily rate report advertisement and selection process can include, for example: an IPHONE, mobile phone, handheld mobile device, TV set-top box, gaming system, television system or other data entry point device; a consumer advertising platform; a daily rate report generating action; a data entry point device and email notification to user of current loan quotes.

In an embodiment, licensed mortgage brokers or banks purchase advertising impressions for mobile phones, set-top boxes, DVRs, game console devices, handheld devices or other data entry point devices in cost per thousand (CPM), cost per referral, cost per click, cost per transfer or another advertising purchase metaphor and provide the service provider with proper information, rates and audience profiles. The information is loaded into the consumer advertising platform or routed to third party pricing engines for calculating and displaying very specific targeted loan quote advertisements from multiple licensed mortgage brokers/banks simultaneously to the user.

Additional services can be available for advertisement delivery of rates and driving traffic back into the mobile phone, set-top box, DVR, game console, handheld or other data entry device to view additional advertised rates. The additional services can include: 1) rate watch, which allows a user to have the consumer advertising platform monitor for specific target rates, notifying them via their data entry device as well as via email, and 2) daily rate reports, which allows a user to receive a periodic or daily notification of the best current loan quotes to their data entry device and email.

The loan quote advertising services in combination allow for different processes to request and receive targeted loan quotes, included process for: basic loan quote response advertisement and selection, rate watch advertisement and selection, and daily rate report advertisement and selection.

As will be appreciated by those having ordinary skill in the art after studying this disclosure, the system and method disclosed herein is for online data entry devices wherein a user enters personal information and loan criteria and this goes into a consumer advertising platform and/or distributed server system(s) that contains the configuration, eligibility rules and pricing for lenders and their investors participating in the program. The service provider or consumer advertising platform instantly returns options of loan quote pricing to the customer, and at this point does not transfer any information to the lenders. Stated another way, the service provider or consumer advertising platform provides a loan quotation to the consumer data entry point. This allows the customer to privately add, change information, re-price and check rates until they are ready to ‘opt-in’ to a rate and program they like. By a consumer opting-in, via the consumer granting permission by selecting a button or the like provided on the consumer data entry point by the application loaded thereon, the service provider or consumer advertising platform transmits a loan quotation request and consumer contact information to the lender platform. In an embodiment, the service provider platform and the lender platform can be loaded on a single server system or a local area network. Alternatively, the service provider platform and the lender platform and be loaded on separate server systems that are connected to each other via a wide area network such as the Internet.

The service provider can generate revenue by charging potential lenders for displaying the advertised rates to the online, mobile phone, handset, set-top, DVR, game console devices, instead of charging based on direct click-throughs to the lender website, or from a non-rate quoted lead transfer model. Stated another way, the service provider, via the service provider platform, can generate and transmit electronic invoices to potential lenders that have their loan rates displayed in response to a loan quotation request by a consumer.

When a user is presented with a loan quote and selects the option they want, at this point the consumer advertising platform is triggered to track and potentially perform a process where the users' information and advertised rate quote is collected and transferred to the selected lender via XML, direct http post or email. There is no direct click referral from the ‘listed rate’ to another website or web-based lender application, information is controlled and delivered to the lender directly in a way to automatically accommodate their lender platform or their third party customer relationship or lead management system. The user is in control of the pricing and when information is transferred to a lender and who receives it. If the user wants more than one lender to contact them, they can select more than one product (more than on lender) to ‘contact them’. The user controls, when, who and how many lenders they seek to be contacted by. The advertising model disclosed herein can support distributed loan pricing from consumer advertising or third party server, and transfers to the platform and to other lead management systems, but, desirably is integrated with consumer advertising servers to provide an immediate response to be displayed back to the user, and to manage advertising tracking and user information transfers.

The software model disclosed herein protects customer privacy, allows for private re-pricing and only delivers the customers private information to the selected lender at the time that the borrower chooses a mortgage loan quote rate and product. The advertising model, technology and systems to support the mobile phone, handheld device, set-top, DVR, game console, and online marketplace will desirably increase consumer satisfaction, privacy and allow for the individual to have more control in the process.

As previously indicated above, the device application is on the consumer facing front end of an IPHONE, mobile phone, handheld, set-top, DVR, game console or other data entry device. The application provides for configuration, collection, display and selection of one or more loan products. The application process can include the steps of: entering loan criteria; sending a loan quote request to the consumer advertising platform; receiving and parsing the response from the consumer advertising platform; selecting a loan program; and, sending tracking and request(s) for contact to the consumer advertising platform.

In an embodiment, the service provider software provides collection forms for handheld, mobile phone, TV set-tops, DVRs, game console and other data entry point devices for a user to enter loan criteria. Upon completing the form, the potential borrower's information is sent into the service provider and analyzed, returning to the borrower a private list of advertised products and rates offered by multiple licensed mortgage brokers or banks. This private list of advertised rate and/or program information is displayed specifically for the user. In addition to the display and tracking of advertised information, the service provider can offer a service to facilitate contact with a lender. If desired, the user can click on a ‘contact me’ button and select one of the lenders or programs. If a user selects a lender to contact him or her, the user's contact and advertised program information is sent to the lender. Additional information can also be collected for a rate watch for monitoring and notification of a specific target rate as well as a daily rate report for periodic notification of current rates to the specific user circumstance.

As indicated above, an initial step in the process for obtaining a loan quote pertains to entering loan criteria whereby, upon entry or opening of the application, and if a new user is coming to the application for the first time, the loan criteria tab is automatically selected, displaying a form to collect information. If information has already been captured, upon entry, the application may automatically initiate a request for pricing.

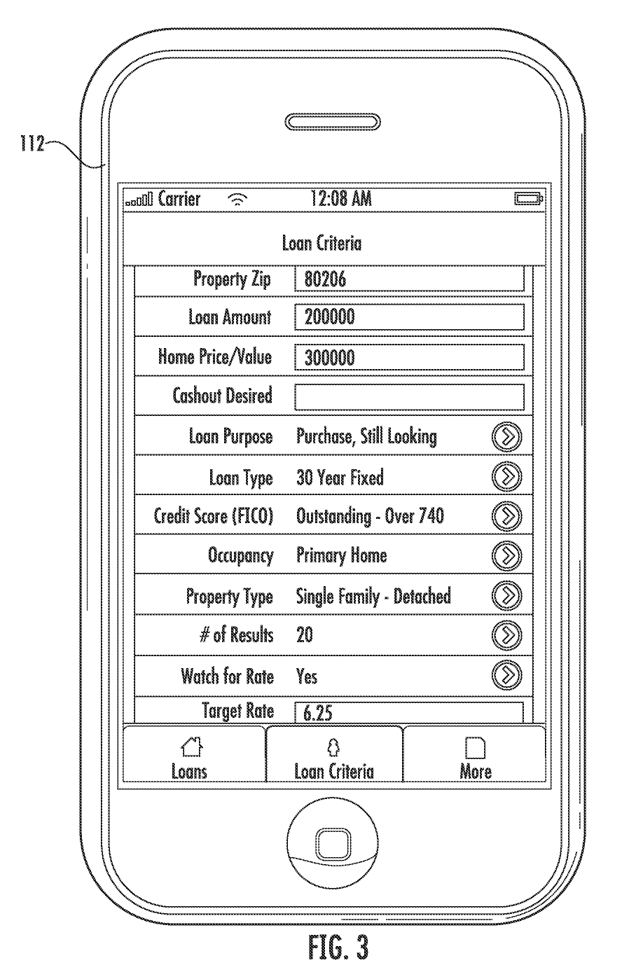

As shown in FIG. 3, the information collected by the form to display the targeted advertising quotes and facilitate the ‘contact me’ button can include: name; email; phone number; phone number extension; property zip code; loan amount; home value/price; cashout; loan purpose (transaction type); property type; occupancy type; loan type; buydown points; credit profile (outstanding, very good, good, reasonable, fair, needs work, need more work); veteran, and, number of results. Additional information collected to facilitate reminders for further advertising can include: watch for rate; send daily email; NotificationId; and, target rate. Moreover, additional ‘behind the scene’ information can be captured for use of unique identification, transaction tracking and other tracking and pricing purposes. This can include: NoUpdate (to determine whether to update data before pricing); UID—unique identifier which is the mobile device's unique identification number; OperationUser—key for security; PartnerId—for tracking and filtering by a specific partner; SourceID—for tracking and filtering by a specific device type and, TransactionID—To track the individual transaction.

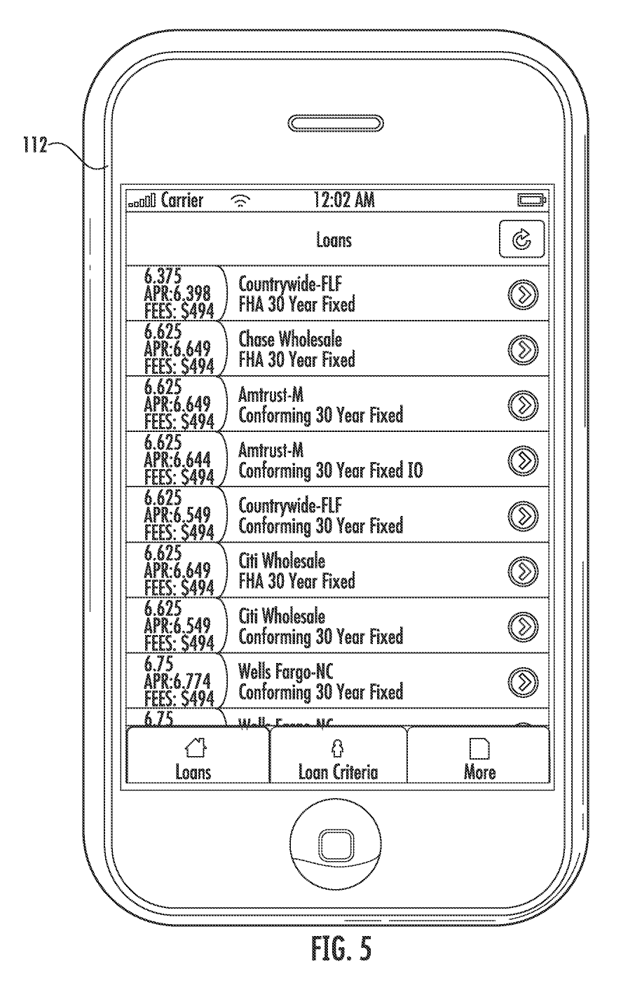

After completion or re-editing of loan criteria, the user can click on a button to request loan quotes as shown in FIG. 3. This sends the information to the advertisement platform for eligibility and pricing. As shown in FIG. 5, a list is displayed of the products returned from multiple mortgage brokers, banks and lenders, with lender name, rate, APR closing cost, and product information. In an embodiment, sending in a search also enables or changes a rate watch and daily rate report setting, if desired by the user.

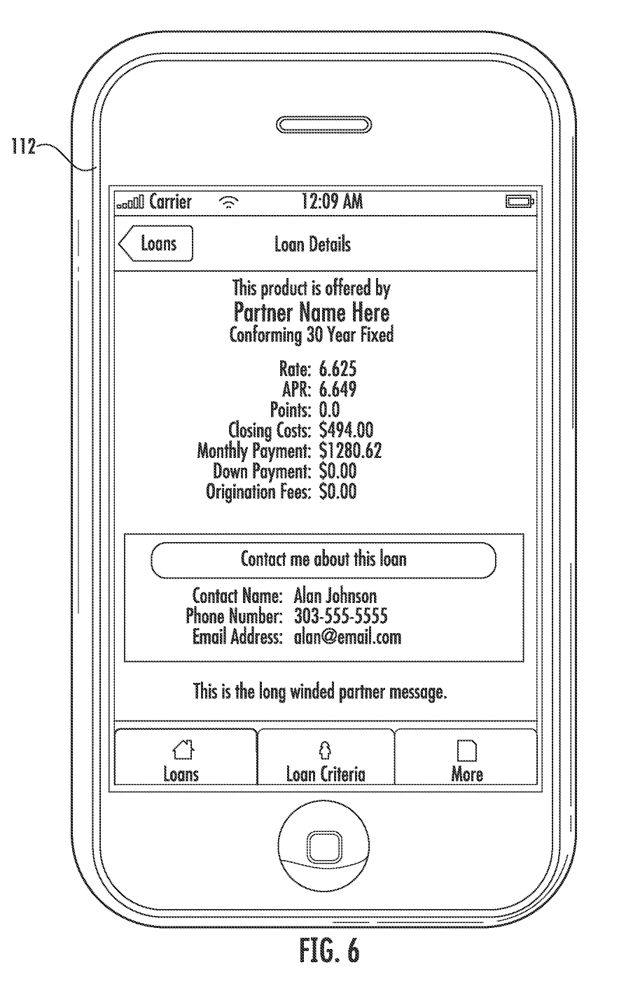

From the list of loan quote advertised products, a user can select a button to view loan program details as show in FIG. 6. This can include, for example: lender name, rate, APR, closing fees, buydown points, origination fees, down payment, monthly payment, lender statement, licensing information, logos and images, and lender contact and tracking urls. On the detail page shown in FIG. 6 is a ‘contact me’ button the user can hit to select the program. Clicking the detail link on the ‘contact me’ button sends information back to the consumer advertising platform, which triggers tracking, collects and sends all the collected borrower information in addition to the loan program information to the selected lender's system lender platform, or another third-party system via XML, http post or email. Selection is not a direct hand-off to a lender's customer facing website, or a click through. Information triggering and transfer of user data is all preferably handled by the consumer advertising platform.

In an embodiment, a user can select as many programs and be contacted by lenders of their choosing. The click through referral and display counts of advertised loan products for each lender can be stored in the advertising platform. Furthermore, the steps for editing criteria, pricing, re-pricing, selecting a product, requesting to be contacted by a lender, setting and turning off rate watches and daily rate reports can happen in any order. Moreover, identical process examples can exist for other phones, handheld devices, IPAD, TV and satellite set-top boxes, DVR and DVR services, game consoles and other data entry point devices.

Preferably, but not necessarily, the system described herein is a fully-featured lead management (LMS), customer relationship management (CRM) and automatic eligibility and pricing platform (PPE). Preferably, the system is a web-based platform designed for companies that range from a single office with few loan officers to large firms who require unlimited users, numerous branches or those who have complex needs. The system can exist on a single server, or in an enterprise rollout can have multiple servers scattered across the United States. The system offers configuration options specifically for how a lender runs its business, supporting retail, wholesale banking, online and traditional use. In an embodiment, the system can support instant point-of-sale offers on any company or partner website. In addition to LMS, CRM and PPE, the high level capabilities of the system can also include: website point-of-sale with instant offers (POS); rate watch and daily rate reports; managed lenders; rate sheet generation; LOS and third party integration.

The eligibility and pricing (PPE) provided by the system can include, for example: managed eligibility and rate sheets; fully adjusted pricing engine; profitability inclusion; automated bidding; best execution; lead re-pricing; saved scenarios; upload documents; rate watch; on-the-fly profitability changes; self-definable investor; pre-processing rules engine; retail or banking configurations; fully automated bidding; rate sheet generator; and, full lock desk support.

The lead management (LMS) provided by the system can include, for example: accepts leads from multiple lead source companies; intelligent rules routing; loan officer quotas; alert notification; lead source integration; definable groups; assignment algorithm selection; lead profiling; and, automatic reassignment for un-worked leads.

The customer relationship management (CRM) provided by the system can include, for example: automated bidding offer email; custom workflow/statuses; loan/system characteristic profile and status-based tasks; loan/system characteristic profile and status-based emails; email drip campaigns; email tracker; ‘pick and send’ emails; daily rate report; history and status tracking; document upload; and, task and emails rules engine.

The third-party integration provided by the system can include, for example: export/import Fannie 3.2>LOS; 32+lead source integrations.

The business reporting provided by the system can include, for example: conversion; task completion tracking; lead source and LO performance; transaction performance; pipeline; branch; and, dashboards. Also, the hosting options can include, for example outsourced or in-house hosting.

The system notes can include, for example: independent application server; unlimited users; targeted managed investors; unlimited branches; and, flexible configurations.

Preferably, but not necessarily, the system is an enterprise-class web-based system that is sold as software and implemented in a mortgage broker/banks' environment or is hosted with a company they choose. Desirably, but not necessarily, the system is not a web-based service controlled by another firm. Private and secure, the system and all data remains 100% under the broker/banker's control, offers a uniquely powerful feature set, and integrates with other mortgage technology solutions and workflow processes.

In an embodiment, one capability of the system is its ability to automate loan pricing in real time and manage profitability for mortgage brokers and banks. Based on customer preferences, the system bids multiple products from multiple lenders simultaneously to produce fully qualified, fully adjusted best execution priced loans—the best-priced loan for customers with the highest possible margin for the broker. The system only recommends rates and products that meet margin criteria as determined by the broker/banker. Margins can be state-by-state, by lender product, by lender or by loan amount. Margins can be a specific dollar amount or in points, and mortgage brokers can add ‘hidden’ margins for the house. Margins can be changed, based upon loan characteristic profiling as part of Overrides Engine. There is also a permission-based, option where brokers/banks can reveal non-qualifying products to loan officers, and information on why that product was not recommended—from ‘not enough margin’ to ‘did not meet LTV criteria.’ Preferably, the system provides the broker and customer with the best loan price and enables daily and loan-by-loan changes to manage loan profitability and volume. Accurate pricing and minimum margin criteria eliminate margin loss from unforeseen errors.

The system also allows brokers and bankers to perform on-the-fly what-if recalculations and also allows loan officers to tweak pricing with the customer, examine detailed information for each loan, and save scenarios that the loan officer can use to lock the loan or return to later. Loan officers can request locks for a saved scenario, transferring links and all data to a built-in online lock desk, or seamlessly export loan, pricing and loan application data to a Loan Origination System (LOS) such as Calyx Point, Genesis, FannieMae's 3.2 format or even SalesForce.com.

The system can be used in a back-office capacity for loan officers who might be working directly with a potential customer or in a completely automated fashion for a ‘lights-out’ lending model, where the system accepts an XML, feed from an external lead source like a website or a lead aggregator like LENDINGTREE, runs the lead through the engine, selects the best loan(s), forms a custom reply and sends back a response—all in a few seconds. Using their native XML formats, the system accepts leads automatically and has its own XML specification for taking in leads and responding from any other source (a company website, for example), making the system a multi-channel automated lead pricing solution. The ‘lights-out’ lending model allows mortgage brokers and banks to instantly serve lockable, best execution pricing to the customer.

There are a number of unique features with the automated bidding process that provide a higher level of service and also integrate with loan processes. In addition to best execution pricing, the system handles loan officer task management with automated features, alerts, emails and integrated calendar. For example, the system automatically manages assignments of incoming leads to loan officer based on profiles, quotas, loan officer weighting and history, giving the mortgage broker incredible granularity on how they want assignments to be made, and then not having to make them manually. Incoming loan leads are automatically set-up in the system, routed to loan officers who are alerted to the new lead and assigned tasks associated with that lead. All loan application information and auto-recommended loan scenarios are pre-saved, so that with one-click, the loan can be locked by the loan officer, or the information passed to a third-party loan origination system. Beyond selecting the best execution loan the system will examine the incoming lead and automatically split the loans that meet certain criteria into a 1st and 2nd loans to avoid mortgage insurance, jumbo or super-jumbo loan penalties. Auto-bided responses also include information such as APR calculations, PMI, monthly payments, closing costs, verification documents, and custom messages to provide full disclosure, increased pricing transparency and a warm fuzzy to potential customers.

The system also performs customer relationship management (CRM) functions, automatically delivering custom emails to customers based on specific loan information/profiles and time passed within a loan status(es). The system manages calendars and sends reminders as well, without any need for loan officer work or intervention.

Pricing in the system is accurate because of the flexible way the software handles adjustments, program rules, SRPs and other variables that differ between lenders and loan programs. The system enables clients to create an unlimited number of adjustments with various complexity, using ‘natural language’ keywords and operators. Adjustments are completely customizable, editable and configurable without writing a single line of code. There are also copy functions for rapid adjustment creation and reuse.

In an embodiment, one item that sets the system apart from early pricing systems is the ease by which adjustments can be written and tailored to the mortgage broker or banks' specific situation or business desires. In many cases, each mortgage broker or bank negotiates their own special ‘deals’ with larger lenders that give them pricing. They often get temporary incentive adjustment ‘bumps’, or negotiate breaks that others would not receive. Since the system is a distributed model, brokers/banks can configure the engine to their exact circumstance. This means loan pricing in their system installation is their exact fully-qualified, fully-adjusted pricing which can be immediately locked.

In addition to providing exact pricing base on a customer's information, the system can also generate aggregated best pricing ‘rate sheets’ that are more common to traditional methods used by loan officers to price loans. The system analyzes lender pricing to produce ‘Best Rate’ and point combinations at each rate value to generate typical looking rate sheets for the mortgage broker/bank. These rate sheets differ, however in that the loan officer can access them online and can request to apply as many adjustments, SRPs as possible, show only incentive adjustments, or if desired straight base pricing. Rate sheet reports can be output in Excel, HTML or PDF.

The system can allow the local administrator to configure various aspects of the product, down to what items appear in pop-up menus, if desired. The system comes fully configured, but the mortgage broker/bank can change underlying items, most of which are exposed in the ‘Parameters’ area. Here, the system allows the broker/banker total access to control hundreds of different ‘behind-the-scenes’ parameters including defaults, margins, codes, loan categories, keywords, FHA loan limits, GSE loan limits, ARM Indexes, holidays, automatic purge functions and many, many other parameters.

The system is also designed to import lender price sheets at the click of a button using the import manager functionality, or have pricing automatically brought into the system with the system bots. With import manager, the system provides quick tools to for the mortgage broker/bank to teach the system how to read lender excel price sheets, making rate updates a snap. Update of lender pricing requires a single click. The system brings spreadsheets into the engine, tears apart the data and updates pricing automatically.

The system offers web and email bots for automatic price monitoring and updating.

Web bots ‘pretend’ they are user. They will login and navigate to an excel spreadsheet, download it to the server, create a new price sheet in the system, update the pricing and then notify an administrator, including any inconsistencies to warn the administrator of possible format changes.

Email bots monitor an email account ‘looking’ for new price sheet. The email bot looks for certain criteria. When it finds an email to process, it will download the attached excel rate sheet to the server, create a new price sheet in the system, update the pricing and then notify an administrator. Again, including any inconsistencies to warn the administrator of possible format changes. Web bots and email bots are typically run on a schedule throughout the day monitoring for changes.

Not all investors will send price sheets via emails, and not all websites can be navigated to retrieve their price sheets, but the system bots will allow a number of price sheets to be automatically updated and reduce the maintenance for the lenders.

In an embodiment, the system offers a complete online lock desk, secondary lending and pipeline management, including support for online locks, generating task lists, expiration tracking, online alerts, RSS (Really Simple Syndicate) notifications and pipeline graphs. Users will receive online alerts and RSS notifications for rate changes, locked loans, lock requests, new assignments, lock status changes, and locks for loans that are about to expire but haven't closed and failed auto-bids.

With the system, brokers/banks can backup or restore all system data in seconds. Through a front-end interface, the system will back up all information in an XML format, which can be restored in total or table-by-table in a single click.

In an embodiment, the system accepts mortgage leads from other lead source companies. Preferably, the system supports all organizations of varying lender needs and sizes. Product editions can also offer configuration options specifically for retail, wholesale banking, online and traditional use. The system is web-based and can additionally support mobile Pocket PC and IPHONE and other device browsers.

In an embodiment, the standard edition of the system is a fully-featured lead management, customer relationship management and automatic bidding platform. This edition is designed for companies with thirty or larger loan officers, branching operations, or companies who wish to have a unified lead management, pricing, and customer relationship management (CRM) system for every lead source and every aspect of the sales process. The standard system provides an eligibility and pricing engine, re-pricing capability, Fannie Mae 3.2 import and export, multiple lead source management, managed lenders, rate watch, daily rate reporting and a full CRM system that includes custom workflows, tasks, drip and push email campaigns, and an email tracker. The standard system is a dedicated system server that can be hosted internally or in a lender's datacenter. The standard system can optionally support instant point-of-sale offers on any company or partner website with the system web component described below. The standard edition of the system can be configured for retail or banking operations with ease.

An enterprise edition of the system can be geared for lenders who require unlimited users, numerous independent net branches, large number of loan officers or have complex needs. The enterprise edition offers multiple system servers that can exist in a single hosting environment or be scattered across the United States. The enterprise edition can feature the loan traffic cop which intelligently routes leads to different application servers based on rankings and rules defined by a lender's corporate headquarters. Investor guideline and pricing data can be centrally managed and replicated across multiple servers.

A system web component can allow for a company to turn its websites and partner websites into an instant offer system that provides a shopping experience, while also intelligently assigning loan officers, generating emails, finding best execution pricing and spawning tasks. This component allows lenders to leverage existing realtor relationships, employee partners, other websites and partner companies. They can offer their partners the ability to embed the system web component instant offer components on their websites and have those leads come straight to them, and be automatically assigned, routed, priced and generate high-touch communication emails straight to the borrower.

In an embodiment, the system web component is a retail point-of-sale website solution that provides system integration. The semi-custom websites provide traditional mortgage website functionality, but also offer instant display of qualified, fully-adjusted pricing when combined with the system. The system web component pushes qualification and pricing forward to the point of sale, so that system web component lenders have a value proposition for the borrower and will be more likely to capture web-based business. The system web component can be used for marketing and to gain direct retail borrowers, or it can deliver a wholesale lending experience behind a company website login. The system web component can be hosted, or brought in-house and the instant pricing components of the system web component can be integrated into a mortgage broker or bank's existing website. The system web component supports a concept of referring ID. Based on referring ID, different co-branding, form questions and results can be displayed and the system can make on-the-fly adjustments to react differently for pricing, emails and tasks for each different referring ID partner. The system web component forms and functionality can be added to any partner's website such as financial planners, accountants, real estate offices and personalize loan officer websites.

In an embodiment, the system web component functionality includes, but is not limited to: web point of sale; multiple partner website component; short lead form; mini-1003 lead form; instant autobid offer; and, opt-in online lock request.

Exemplary embodiments of the invention can be implemented as instructions stored on a machine-readable medium, which can be read and executed by a computing platform to perform the operations described herein. A machine-readable medium can include any mechanism for storing or transmitting information in a form readable by a machine (e.g., a computer). For example, a machine-readable medium can include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” “in an embodiment,” or “in an exemplary embodiment,” do not necessarily refer to the same embodiment, although they may.

In the description and claims, the terms “coupled” and “operatively connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “operative connected” or “coupled” may also mean that two or more elements are not in direct contact with each other, but yet still co-operate or interact with each other.

An algorithm is described directly or indirectly herein, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose device selectively activated or reconfigured by a program stored in the device.

The foregoing describes only some embodiments of the present invention and modifications, obvious to those skilled in the art can be made thereto without departing from the present invention. It should, therefore, be emphasized that the above-described embodiments of the present invention, particularly, any “preferred” embodiments, are possible examples of implementations merely set forth for a clear understanding of the principles for the invention. Many variations and modifications may be made to the above-described embodiment(s) of the invention without substantially departing from the spirit and principles of the invention. All such modifications are intended to be included herein within the scope of this disclosure and the present invention, and protected by the following claims.

What is claimed is:

1. A system comprising:
a consumer data entry point device operatively coupled, via a network, to one or more severs for entering personal data, securely transmitting the personal data and receiving a responsive loan quotation or rate watch report via an application loaded on the data entry point device or by email or another consumer selected notification setting;
a service provider or consumer advertising platform that provides the loan quotation or the rate watch report from one or more different lenders to the consumer data entry point and transmits a loan quotation request and consumer contact information upon permission being granted by the consumer via the application loaded on the data entry point device.

2. The system of claim 1, further comprising a lender platform for generating the loan quotation, in response to the loan quotation request from the service provider platform, and receiving contact information for a consumer from the service provider platform.

3. The system of claim 2, wherein the consumer advertising platform and the lender platform are provided on a single system.

4. The system of claim 2, wherein the lender platform offers to provide loan quotations via a website associated with a lender or a partner of the lender.

5. The system of claim 1, wherein the application is available for downloading from a server that offers other applications available for downloading.

6. The system of claim 1, wherein lending rates are watched and reported to the consumer data entry point in response to a request made by the consumer and the entered personal data.

7. The system of claim 1, wherein the loan quotation is provided by a lender that pays the service provider to post the loan quotation.

8. The system of claim 1, the consumer data entry point device comprising a cellular telephone.

9. The system of claim 1, the consumer data entry point device comprising a television and a cable set top box.

10. The system of claim 1, the consumer data entry point device comprising a gaming system.

11. The system of claim 1, the consumer data entry point device comprising a handheld device.

12. The system of claim 1, the system comprising an eligibility and pricing engine.

13. The system of claim 1, the consumer data entry point device comprising a digital video recording (DVR) device.

14. The system of claim 1, the service provider platform providing lead management to the lender platform related to the loan request and requests from other consumers.

15. The system of claim 1, the service provider platform providing customer relationship management to the consumer related to the loan quotation request.

16. The system of claim 1, the consumer advertising platform providing a loan qualification response to the consumer data entry point and relaying a selection response to a selected lenders.

17. A system comprising:
a cellular telephone operatively coupled, via a network, to one or more severs for entering personal data, securely transmitting the personal data and receiving a responsive loan quotation via an application loaded on the cellular telephone or by email or another consumer selected notification setting;
a service provider or consumer advertising platform that provides the loan quotation to the cellular telephone and transmits a loan quotation request and consumer contact information upon permission being granted by the consumer via the application loaded on the data entry point device.

18. The system of claim 17, wherein the application is available for downloading from a server that offers other applications for downloading.

19. The system of claim 18 further including a lender platform for generating the loan quotation, in response to the loan quotation request from the service provider platform.

20. The system of claim 19, wherein the consumer advertising platform and the lender platform are provided on a single system.

21. The system of claim 19, wherein the lender platform offers to provide loan quotations via a website associated with a lender or a partner of the lender.

22. The system of claim 18, wherein lending rates are watched and reported to the cellular telephone in response to a request made by the consumer and the entered personal data.

23. The system of claim 18, wherein the loan quotation is provided by a lender that pays the service provider to post the loan quotation.

24. The system of claim 18, the system comprising an eligibility and pricing engine.

25. The system of claim 18, the service provider platform providing lead management to the lender platform related to the loan request and requests from other consumers.

26. The system of claim 18, the service provider platform providing customer relationship management for sending reminders to the consumer related to the loan quotation request.

27. A system comprising:
an application available for downloading from a server that offers other applications for downloading;
a cable set top box, gaming system, or handheld device operatively coupled, via a network, to one or more severs for downloading the application, entering personal data, securely transmitting the personal data and receiving a responsive loan quotation;
a service provider or consumer advertising platform that provides the loan quotation to the cable set top box, gaming system, or handheld device and transmits a loan quotation request and consumer contact information upon permission being granted by the consumer via the application loaded on the cable set top box, gaming system, or handheld device; and,
a lender platform for generating the loan quotation, in response to the loan quotation request from the service provider platform.

28. The system of claim 27, wherein the consumer advertising platform and the lender platform are provided on a single system.

29. The system of claim 27, wherein the lender platform offers to provide loan quotations via a website associated with a lender or a partner of the lender.

30. The system of claim 27, wherein lending rates are watched and reported to the cable set top box, gaming system or handheld device in response to a request made by the consumer and the entered personal data.

31. The system of claim 27, the system comprising an eligibility and pricing engine.

32. The system of claim 27, the service provider platform providing lead management to the lender platform related to the loan request and requests from other consumers.

33. The system of claim 27, the service provider platform providing customer relationship management for sending reminders to the consumer related to the loan quotation request.
